(19) United States
(12) Patent Application Publication
(10) Pub. No.: US 2007/0162192 A1
(43) Pub. Date: Jul. 12, 2007

(54) TRAINER FOR RADIO-CONTROLLED VEHICLES

(76) Inventor: Vincent Russo, Prairie du Sac, WI (US)

Correspondence Address: Intellectual Property Department;DEWITT ROSS & STEVENS S.C., US Bank Building, 8000 Excelsior Drive, Suite 401, Madison, WI, 53717-1914, US

(21) Appl. No.: 11/567,446

(22) Filed: Dec. 6, 2006

Related U.S. Application Data
(60) Provisional application No. 60/756,670, filed on Jan. 6, 2006.

(51) Int. Cl. G05D 1/00; G06F 7/00

(52) U.S. Cl. 701/2; 434/30

(57) ABSTRACT

A trainer system for radio-controlled vehicles in general, aircraft in particular, and more specifically for helicopters. A buddy-box slave unit utilizes a signal transmitted by a master unit to mimic the movements of the control inputs of the master unit.

### CROSS-REFERENCE TO RELATED APPLICATIONS

Priority is hereby claimed to provisional application Ser. No. 60/756,670, filed Jan. 6, 2006, the contents of which are incorporated herein.

### FIELD OF THE INVENTION

The invention relates to radio control systems for vehicles in general and aircraft in particular. In the preferred version, the invention is directed to a trainer system to teach operators how to fly radio-controlled aircraft in general and radio-controlled helicopters in particular.

### BACKGROUND

Flying radio-controlled aircraft (hereinafter r/c aircraft) has been a popular hobby for decades. From the simplest fixed-wing, single-engine, propeller-driven aircraft, to large-scale jet-powered aircraft, to the most complex and realistic of rotary-wing aircraft (i.e., helicopters, autogyros, gyrocopters, and hovercraft), the challenge of mastering the ability to fly an aircraft by remote control continues to capture the fascination of many. For most, it is a challenging hobby. However, militaries around the world also make use of r/c aircraft for reconnaissance, battlefield photography, and for actual combat. The ability to fly these military r/c aircraft with precision, under difficult conditions, is a very highly prized skill.

Mastering the ability to pilot r/c aircraft, however, is neither cheap nor easy. Training mistakes can be frightfully costly. Addressing the civilian hobby market, fixed-wing and rotary-wing r/c aircraft can be obtained commercially at costs ranging from the low hundreds of dollars to tens of thousands of dollars. Likewise, radio controllers (e.g. transmitters) of various degrees of sophistication can be obtained commercially in roughly the same price range. While it is fairly rare that the radio controller itself is damaged (most often due to an accidental drop onto a hard surface), virtually every r/c aircraft enthusiast has suffered through the anguish, frustration, and embarrassment of a catastrophic crash of an expensive r/c aircraft. It happens alike to novices first learning to control their aircraft, and to seasoned veterans attempting ever more complex maneuvers with their aircraft. In either instance, the result is the same: aircraft damage ranging from minor dings and dents, to complete and utter destruction of the craft.

There are specific frequencies assigned by the Federal Communications Commission (FCC) for use with airborne r/c models in the United States. A modeler must ensure that the system that he chooses is operating on one of these frequencies. The vast majority of radio systems in use by hobby r/c fliers use one of two types of modulation systems to help to nullify interference: pulse position modulation (PPM) and pulse code modulation (PCM). These two systems are well known and will not be described in any detail herein.

In order for a r/c vehicle to be controlled, the driver or pilot must be able to input control movements which are sent to the model and translated into control surface movements (e.g., the steering of the wheels in a land vehicle, or the movement of a rudder in a boat, or the movement of flight control surfaces in an aircraft). This is the sole purpose of the radio control system. A conventional radio transmitter for controlling vehicles comprises an input device, an encoder, a radio frequency (RF) section, and an antenna. The input device or controller most commonly comprises a pair of two-axis, gimbaled joysticks. Other input devices, such as knobs, switchs, slide controls, etc. are known. Basically, each of these devices set a particular resistance value that represents a particular type of movement or input. These manual control inputs are the means by which the driver or pilot uses to relay needed control movements to the radio-controlled vehicle. The actuation of an input device is emulated in some way within the vehicle, depending on the nature of the vehicle and the control surface being manipulated. That is, a fixed-wing craft requires throttle control and the ability to move the ailerons and the rudder, while a helicopter requires throttle control, but also the ability to control the speed and pitch of the main rotor and the tail rotor. Radio-controlled cars and boat require analogous controls.

The input devices are connected to potentiometers, which convert the positions into voltages. A dedicated integrated circuit called an encoder reads these voltages and produces a stream of pulses that is then sent to the RF section. The pulses are set to specific values as determined by the value of the input device and placed in a stream called a pulse train. The pulse train is a series of square wave pulses that are about 300 microseconds in width.

The RF section is the part of the transmitter that actually generates the radio signal. The pulse train is interpreted by the RF section and a particular amplitude or frequency variation is generated to represent the pulse train. The radio signal is sent to the antenna and radiated from the transmitter. The receiver within the vehicle consists of a radio receiver, a decoder, and a servo buss.

A radio receiver section within the vehicle receives the radio signal. The signal is then demodulated into a pulse train. The decoder then directs the pulse to a particular port or connector on the servo buss. The servo is the device that actually does the work in the system. A servo is a bi-directional motor that receives the pulse from the channel into which it is plugged or assigned. Each servo includes a circuit that directs the rotation of the motor to a particular position based on the pulse signal. This position determines the current position of the corresponding control surface that the servo controls.

To minimize vehicle crashes several r/c flight training aids have been developed. For example, a “buddy box” is a common training aid used to teach novices how to fly fixed-wing aircraft. A “buddy box” r/c system is essentially an extra control sub-assembly (usually a pair of joy-sticks) operationally connected to a fully operational master transmitter. The two units are operationally linked to one another in a master-slave relationship. In use, an instructor controls the master unit and a student controls the slave unit (which has the control sub-assembly, but lacks a transmitter of its own). The instructor can transfer control from the master unit to the slave unit (and vice-versa resume control) by throwing a switch that dictates whether the master unit controls are functioning or the slave unit controls are functioning. In this manner, an instructor can teach a student how to control the aircraft, while simultaneously retaining the ability to resume control of the aircraft prior to a catastrophic crash.

A typical buddy box consists of most of the same basic components of a transmitter. Internally, the only important part of the buddy box is the encoder. This is the component that makes the buddy box system function.

A conventional buddy box gets its power through the trainer cord from the master unit. The master unit powers up the slave unit through the buddy cord and the encoded pulse train is carried by a single wire from the slave unit to the master. When the instructor switches on the trainer switch, power goes from the master to the encoder of the slave unit and powers it up. The slave unit components become the remote controls and encoder for the master unit. The controls sticks and encoder of the master unit do not function as long as the trainer switch is held on. This allows the slave unit to become the controlling unit. The pulse train from the slave unit is interpreted by the RF section of the master unit and a particular amplitude or frequency variation is generated to represent the pulse train. The radio signal is carried to the antenna and radiated from the transmitter. The buddy box continues to operate as long as the trainer switch is held by the instructor. When the trainer switch is released, power is removed from the encoder of the slave and it no longer operates.

Notably, however, a conventional buddy box arrangement will only function with fixed-wing aircraft. In practice, the instructor gets the fixed-wing craft airborne and sets it on a steady path (such as a circular path of a suitably large radius) using the master controller. Control of the aircraft is then switched to the student, who uses the slave controller. The momentary lapse in control during the switch from master to slave is harmless because a fixed-wing craft is aerodynamically stable; even if the controls of the slave box are positioned at considerably different points than the master box at the time of transfer, the stable aerodynamics of a fixed-wing craft give the student just enough reaction time to right the aircraft and to keep it in stable flight.

The same cannot be said for rotary-wing aircraft, such as helicopters. Helicopters and the like are notoriously unstable aircraft. Unlike fixed-wing aircraft, which will fly a considerable distance under zero power, a helicopter is aerodynamically unstable. One moment of inattention at the controls, and a r/c helicopter will plummet to earth. Even the most simple of radio-controlled maneuvers with a helicopter—e.g., hovering and transitioning from hovering to stable forward flight and vice-versa—are surprisingly difficult to learn. A buddy box system cannot be used with rotary-wing r/c aircraft because the momentary lapse in control during the switch from master to slave is enough to cause the craft to crash. The controls of the master unit simply do not exactly match those of the slave unit at the time the transfer of control is made. As a result, when control of the rotary-wing craft is switched from master to slave, the aircraft spins out of control and crashes. Even if seasoned fliers are manning the master and slave units, it is impossible to maintain control of a rotary-wing aircraft at the time the switch is made.

Therefore, a long-felt and unmet need exists for a r/c system that can teach students (both novices and pros alike) how to control r/c aircraft in general and r/c rotary-wing aircraft in particular.

### BRIEF DESCRIPTION OF THE FIGURES

FIG. 1 is a schematic diagram of a first version of the training system according to the present invention.

FIG. 2 is a schematic diagram of a second version of the training system according to the present invention.

### DETAILED DESCRIPTION OF THE INVENTION

The present invention comprises a remote control system or training device for use in training a student to fly r/c vehicles in general, r/c aircraft more specifically, and r/c rotary-wing aircraft in particular.

As noted previously, a “buddy box” arrangement is known in the art, as are transmitters for controlling r/c aircraft. These systems are described in the Background and shall not be discussed in any greater detail herein. Conventional r/c transmitters and “buddy box” systems are commercially available from a number of worldwide manufacturers and vendors, including, for example, Futaba Corporation (Chiba, Japan), Futaba Corporation of America (Irvine, Calif.), and Hobbico, Inc. (Champaign, Ill.).

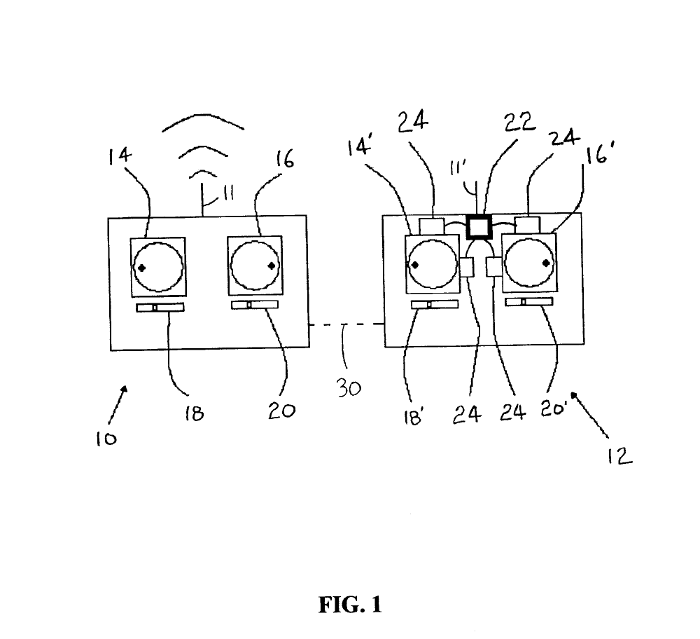

A first version of the invention (and the preferred version of the invention) is illustrated in FIG. 1. The invention comprises a master controller unit 10 (which can be a conventional r/c transmitter, as shown in the figure, or a computer-controlled signal generator that models the control positions of an r/c aircraft) and a slave unit 12. For purposes of the following discussion, the master controller unit 10 shall be taken to be a conventional r/c controller of known design. This is for purposes of brevity only. The master controller unit 10 can be any type of wireless control unit, now known or developed in the future, that operates on any wireless principle (e.g. radio, microwave, laser, etc.) As described in greater detail later, the master controller unit may also be a programmable computer that displays the motion of a model vehicle on a screen while simultaneously generating a signal stream required to make a real-world vehicle perform as illustrated on-screen.

The master controller unit 10 generally comprises one or more manual control inputs 14, 16, 18, and 20. In FIG. 1, the manual control inputs 14 and 16 are depicted as gimbaled joysticks, while manual control inputs 18 and 20 are depicted as corresponding sliders. The remaining conventional elements of the master unit 10 are omitted from FIG. 1 for clarity.

The invention further comprises a slave unit 12 that is operationally linked to the master unit 10. The operational link is preferably wireless via antennae 11 on the master unit 10 and antennae 11′ on the slave unit 12. However, the two units may also be connected via a hardwire connection 30 (although this is not preferred). The slave unit 10 preferably is not a transmitter, but rather only a receiver. However, a transmitter may be incorporated into the slave unit so that it can alternatively act as either the master unit to another slave or as the slave (as shown in FIG. 1). It includes one or more manual control inputs 14′, 16′, 18′, and 20′ that mirror the manual control inputs of the master control unit 10. The slave unit 12 receives r/c signals generated by the master unit and decodes those signals to position the gimbaled joysticks 14′ and 16′ of the slave unit, and the trim controls 18′ and 20′ in the exact same relative position as on the corresponding controls on the master unit. This is done via a receiver/servo buss 22 and servos 24. The servos 24 are operationally linked to the joysticks and trim controls to move these elements according to the decoded signals provided to them by the receiver/servo buss 24. In short, the master unit 10 generates a conventional r/c pulse train that is transmitted both to the r/c vehicle being operated and to the slave unit 12. The slave unit then decodes the pulse train (in conventional fashion) and directs the decoded pulse train to the servo buss. The servo buss then sends the decoded pulse train to the corresponding servos 24, which move accordingly so that the positions of the controls on the slave unit exactly match those on the master unit.

In this fashion, the servos 24 in the slave unit 12 mimic the movements generated by the joysticks and other control elements within the master unit 10. At the same time, the servos within the r/c vehicle being operated cause the vehicle to move in the desired fashion. Thus, the student simply places his hands on the slave unit to feel how the manual control inputs are moved to cause the vehicle to move in a corresponding fashion. In this manner, the student is able to learn the proper stick movements required to control, for example, a model helicopter, without the risk of damaging the helicopter due to student error. In practice, for example, a well-seasoned r/c aviator uses the master unit 10 to fly the aircraft, while at the same time the student rests his hands upon the slave unit 12 to feel and to learn the stick movements that result in the flight pattern of the aircraft being flown.

As shown in FIG. 1, there is only a single slave unit 12. This is for brevity only. The system may also include a single master unit 10 simultaneously linked to more than one slave unit. This arrangement (one master unit, multiple slave units) allows one teacher to simultaneously teach many students. The teacher controls the sole master unit, while each student has his own slave unit.

As noted earlier, in the preferred version, the master and slave unit(s) are linked through a wireless connection. However, in an alternate version, a hard wire connection may be used between the master and slave units. This might be desirable if rf interference may be present.

Suitable receiver/servo busses 22 can be obtained commercially. For example, Futaba's FP R127DF receiver is perfectly suitable for a slave unit containing 4 servos. Analog or digital receivers and busses may be used. The servos 24 are also available commercially. Futaba also manufacturers a host of suitable servos, in both analog and digital versions. The signal stream generated by the master unit may be directed through a dedicated set of channels reserved solely for the master-slave signal stream, or the signal stream may be directed through any channels that are available and un-used within a multi-channel transmitter. For example, if the master unit is a 12-channel transmitter, and only six channels are required to control the vehicle, the remaining six channels can be used to direct the signal stream to the slave unit(s).

It is also preferred that the receiver/servo 22 of the slave unit be adjustable (i.e. sweepable) so that the slave unit can interpret signal streams operating on different frequencies. This allows a student to take his slave unit, for example, to the flying field, tune the receiver 22 to the frequency being used by a more accomplished flier, and thus have the joysticks on the student's slave unit emulate the movements being input into the accomplished flier's transmitter.

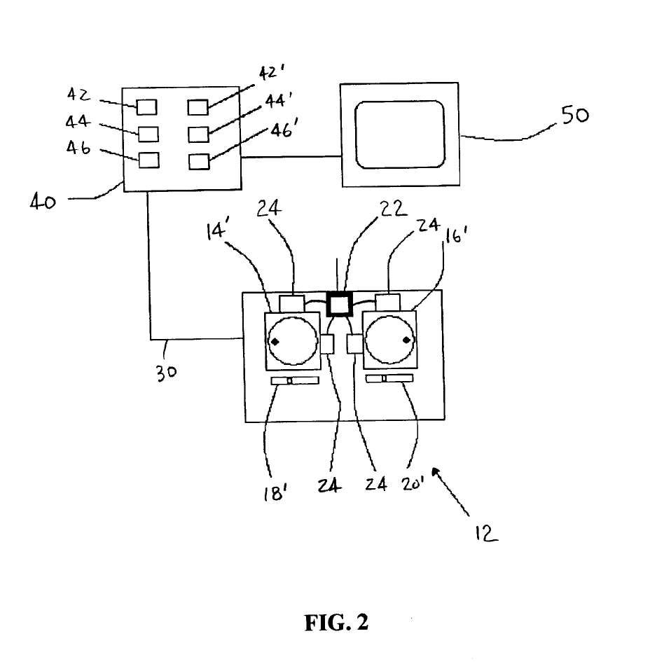

FIG. 2 shows another version of the invention. Here, rather than a master unit 10, the trainer includes a programmable computer 40, that is operationally linked to a display 50 and the slave unit 12. The slave unit 12 is the same as described in FIG. 1, with the exception that the pulse train is generated by the computer 40, rather than the master control unit 10. The connection between the computer 40 and the slave unit 12 may be wireless or via a hardwire connector 30.

The computer 40 is programmed to include controller position files 42, 44, and 46, and corresponding image generation files 42′, 44′, and 46′. The image generation files can be output to the display 50 to display desired maneuvers to be accomplished by the r/c vehicle. For example, the computer 40 generates images of an aircraft in flight (via any of files 42′, 44′, 46′, etc.) and simultaneously generates signals corresponding to the positions of the controllers 14, 16, 18, and 20 needed to make an aircraft fly in the same fashion as shown in the generated images. The signals (stored in files 42, 44, 46, etc.) are transmitted to the slave unit 12, where the positions of the controllers 14′, 16′, 18′, and 20′ mimic the positions required to make the aircraft fly the pattern shown by the computer-generated image files. In this fashion, the student pilot can acquire the “muscle memory” required to accomplish difficult aerial acrobatics or other difficult flight maneuvers without putting his r/c aircraft at risk.

The principal advantage of the invention is that it doesn't simply illustrate or show the student where to put his hands. It actually moves the students' hands to the positions they need to be to make the r/c vehicle execute a desired maneuver.

Of course, the description set out above is merely of exemplary preferred versions of the invention, and it is contemplated that numerous additions and modifications can be made. These examples should not be construed as describing the only possible versions of the invention, and the true scope of the invention defined by the claims included herein.

What is claimed is:

1. A training device for radio-controlled vehicles comprising:
a slave unit dimensioned and configured to decode a signal train generated by a master controller, wherein the signal train is dimensioned and configured to control a radio-controlled vehicle,
wherein the slave unit comprises a receiver which is operationally connected to at least one servo buss, which is operationally connected to at least one manual control that corresponds to a manual input control of the master controller that generated the signal train; and
wherein the slave unit decodes the signal train and dynamically positions the manual control of the slave unit to match movements of the manual input control of the master unit.

2. The training device of claim 1, wherein the at least one manual control of the slave unit comprises a two-axis gimbaled joystick.

3. The training device of claim 2, wherein the at least one manual control of the slave unit comprises two two-axis gimbaled joysticks.

4. The training device of claim 1, wherein the slave unit receives the signal train from the master controller via a wireless connection.

5. The training device of claim 1, wherein the slave unit receives the signal train from the master controller via a hardwire connection.

6. The training device of claim 1, further comprising a master controller, the master controller comprising at least one manual control input, operationally connected to a signal generator, which is operationally connected to a transmitter, wherein the master controller generates a radio signal train that is transmitted to a radio-controlled vehicle and to the slave unit.

7. The training device of claim 1, further comprising a master controller, wherein the master controller is a radio-control unit for a radio-controlled vehicle.

8. The training device of claim 1, further comprising a master controller, wherein the master controller is a radio-control unit for a radio-controlled aircraft.

9. The training device of claim 1, further comprising a master controller, wherein the master controller is a programmable computer operationally linked to the slave unit, and wherein the computer is programmed to generate the signal train that is dimensioned and configured to control a radio-controlled vehicle.

10. A training device for radio-controlled vehicles comprising:
a master controller comprising at least one manual input control and which is dimensioned and configured to generate a signal train to control a radio-controlled vehicle in response to movements of the manual input control; and
a slave unit dimensioned and configured to decode the signal train generated by the master controller, wherein the slave unit comprises at least one manual control that corresponds to the manual input control of the master controller, and wherein the slave unit decodes the signal train and dynamically positions the manual control of the slave unit to match movements of the manual input control of the master controller.

11. The training device of claim 10, wherein the manual input control of the master unit and the manual control of the slave unit each comprise a two-axis gimbaled joystick.

12. The training device of claim 11, wherein the manual input control of the master unit and the manual control of the slave unit each comprise two two-axis gimbaled joysticks.

13. The training device of claim 10, wherein the slave unit receives the signal train from the master controller via a wireless connection.

14. The training device of claim 10, wherein the slave unit receives the signal train from the master controller via a hardwire connection.

15. A training device for radio-controlled vehicles comprising:
a master controller comprising a programmable computer programmed to generate a signal train that is dimensioned and configured to control a radio-controlled vehicle, the master controller operationally linked
a slave unit dimensioned and configured to decode the signal train generated by the master controller, wherein the slave unit comprises at least one manual control and wherein the slave unit decodes the signal train and dynamically positions the manual control of the slave unit to match manual control movements required to recreate the signal train generated by the master controller.

16. The training device of claim 15, wherein the manual control of the slave unit comprises a two-axis gimbaled joystick.

17. The training device of claim 16, wherein the manual control of the slave unit comprises two two-axis gimbaled joysticks.

18. The training device of claim 15, wherein the slave unit receives the signal train from the master controller via a wireless connection.

19. The training device of claim 15, wherein the slave unit receives the signal train from the master controller via a hardwire connection.
